(19) United States
(12) Patent Application Publication
(10) Pub. No.: US 2018/0180411 A1
(43) Pub. Date: Jun. 28, 2018

(54) DEVICE AND METHOD FOR DETERMINING AT LEAST ONE PARAMETER CHARACTERISTIC OF AT LEAST ONE COMPONENT OF A VEHICLE IN THE SCOPE OF A DIAGNOSTIC, MAINTENANCE OR MONITORING OPERATION

(71) Applicant: CEMB S.p.A., Mandello del Lario (LC) (IT)

(72) Inventor: Giancarlo TORRI, Mandello del Lario (LC) (IT)

(21) Appl. No.: 15/304,157

(22) PCT Filed: Mar. 13, 2015
(86) PCT No.: PCT/IT2015/000068

§ 371 Date: Oct. 14, 2016

(30) Foreign Application Priority Data
Jun. 6, 2014 (IT) MI2014A001041

(51) Int. Cl. G01B 11/275; G01S 17/89

(52) U.S. Cl. CPC G01B 11/2755; G01B 2210/143; G01S 17/89

(57) ABSTRACT

Equipment for determining at least one value of at least one parameter characteristic of one or more vehicle component in the scope of a diagnostic, maintenance or monitoring operation, includes at least one time-of-flight sensor for acquiring information relative to the shape and size of the component, and a first processing unit operatively connected to the time-of-flight sensors for receiving acquired data from the latter, so as to be able to calculate the value assumed by the characteristic parameter. The time-of-flight sensor includes an emitter of waves incident on the component of the vehicle, a receiver of the incident waves reflected by the component, and a second processing unit suitable for measuring phase displacements sustained by the waves following the incidence on the component, and for calculating, on the basis of the phase displacements, the distance from the sensor of the points of the component on which the waves impact.

### FIELD OF APPLICATION OF THE INVENTION

The present invention refers to the so-called field of garage equipment or vehicle service systems, hereinbelow referred to as “vehicle service equipment”, i.e. the field which regards the devices employable in a repair shop/garage for carrying out diagnostic, maintenance or monitoring operations on a land vehicle and its components. Hereinbelow in the present description, with the expression “vehicle service equipment” it is intended to identify any one device of the aforesaid type. Included among the vehicle service equipment are the following, by way of example: devices for aligning wheels, balancing machines, devices for mounting and dismounting the tyres, lifts and vehicle inspection systems which, by integrating inspection devices of various type, are capable of providing, during a single inspection, information on the “health conditions” of multiple components of the vehicle.

More precisely, the present invention refers to vehicle service equipment for acquiring, without contact, information regarding the shape of one or more components of a vehicle and/or for measuring, without contact, spatial distances relative to said components, and subsequently determining, on the basis of the acquired information and on the measured distances, the value of at least one parameter characteristic of said components relative to the type of operation (diagnostic, maintenance or monitoring) that is being carried out. With the expression “without contact” it is intended to identify an acquisition or a measurement carried out without any physical contact with the vehicle, object of operation. In particular, the present invention regards vehicle service equipment in which the aforesaid acquisition and/or measurement without contact occur by means of a time-of-flight sensor.

The present invention also refers to a method for determining at least one value of the aforesaid characteristic parameter by means of the vehicle service equipment, object of the invention.

### Review of the Prior Art and Presentation of the Technical Problem

The present vehicle service equipment for acquiring, without contact, information regarding the shape, the size and the position of one or more components of a vehicle, carry out three-dimensional scans of the component (or of the components), object of operation, usually by means of the technique of optical triangulation (as is for example illustrated in the patent application US 2013/0271574 A1).

With reference, by way of example, to the wheel alignment devices, said devices carry out three-dimensional scans of the wheels of the vehicle, object of operation, and starting from said scans and from the knowledge of the mutual position of the different scanning devices, they determine the characteristic size and angles of the wheels, of the steering and of the chassis in order to allow carrying out the alignment of the wheels of the vehicle (as is for example illustrated in the abovementioned patent application US 2013/0271574 A1).

The measurements carried out by an alignment device and, more generally, by vehicle service equipment of the type referred to by the present invention, are more precise the greater the resolution of the three-dimensional scans of the component (or of the components) of the vehicle, object of operation. The more precise said measurements, the better the operation that is carried out on the vehicle; therefore, from that stated above, it is inferred that there is an advantage in carrying out three-dimensional scans with a high resolution. The technique of optical triangulation allows carrying out scans with high resolution but involves costs for manufacturing the sensors such to reduce the market attractiveness of the vehicle service equipment. Alternatively, in order to limit the costs, it is possible to reduce the number of scanning devices, by simultaneously providing the vehicle service equipment with opportune equipment for moving said scanning devices. However, this complicates the mechanics of the vehicle service equipment.

### Objects of the Invention

The object of the present invention is to overcome the aforesaid drawbacks and to indicate vehicle service equipment that constitutes a valid alternative to the present vehicle service equipment which acquire, without contact, information regarding the shape, the size and the position of one or more components of a vehicle by means of optical triangulation.

### SUMMARY OF THE INVENTION

The object of the present invention is vehicle service equipment by means of which it is possible to determine at least one value assumed by at least one parameter characteristic of one or more components of a vehicle, in the scope of a diagnostic, maintenance or monitoring operation completed on the vehicle, the vehicle service equipment comprising:
means for acquiring, without contact, data comprising information relative to the shape of the component of the vehicle and/or at least one size of at least one spatial distance relative to said component;
a first processing unit operatively connected to the acquisition means for receiving said data from the latter, said first processing unit being suitable for calculating, on the basis of the acquired data, the value assumed by said characteristic parameter,

characterized, according to the invention, in that said acquisition means include at least one time-of-flight sensor comprising:
first means for emitting waves incident on a component of the vehicle;
first means for receiving the incident waves reflected by said component;
a second processing unit suitable for:
   measuring phase displacements sustained by the incident waves following the incidence on said component, and for calculating, on the basis of the phase displacements, the distance from the sensor of the points of said component on which the waves impact;
   determining the spatial position of said incidence points with respect to the sensor,

the sensor being capable of generating a depthmap with a resolution not less than 320×200 pixel and having a depth resolution greater than 0.2 mm̂−1. Time-of-flight sensors are substantially known, therefore they will not be discussed in further detail herein. Information regarding the definition of time-of-flight sensors and the operating principle thereof can be found, by way of example, in the following publication: “Time-of-Flight Cameras and Microsoft Kinect”—authors: Carlo Dal Mutto, Pietro Zanuttigh, Guido M Cortelazzo—ISBN 978-1-4614-3806-9.

In the present description, by “depth resolution” of a time-of-flight sensor, it is intended a characteristic parameter of the sensor obtained with the following procedure:
a) framing, by means of the sensor with which it is intended to measure the depth resolution, the shoulder of a dry Pirelli® PZERO® 295/45 ZR20 110Y tyre, after traveling 100 Km on road, the tyre being placed at a distance of 1 m from the sensor, in front of the same, at the center of the framed area, the shoulder being illuminated with 300 lx of solar radiation;
b) generating a multiplicity of depthmaps of the tyre shoulder during an overall time interval of 2.5 seconds;
c) subdividing the time interval of 2.5 seconds into ten consecutive sub-intervals of 0.25 seconds and, for each sub-interval, calculating, for each pixel of a depthmap that can be generated by the sensor, the average value assumed from the measurement of the distance between the sensor and the incidence point of the tyre shoulder corresponding to the pixel, so as to obtain, for each pixel, ten average values of said distance;
   d) for each pixel, calculating the standard deviation of the ten average values of the distance;
   e) determining the reciprocal of the minimum value assumed by said standard deviation between all the pixels corresponding to the tyre shoulder.

The value determined in step e) defines the depth resolution of the sensor.

By “depthmap”, it is intended a graphical representation of the information relative to the distance of said incidence points from the time-of-flight sensor. The concept of depthmap is substantially known; therefore, it will not be discussed in further detail herein.

Preferably, the waves emitted by the time-of-flight sensor are infrared radiations, and still more preferably they have a wavelength belonging to the so-called “near infrared” interval, i.e. they have a wavelength comprised between 0.75 μm and 1.4 μm.

The vehicle service equipment, object of the invention, rather than using optical triangulation, employs time-of-flight sensors having a resolution of the depthmap and with depth sufficiently high to allow carrying out a resolution scan comparable to that obtainable by means of optical triangulation, at costs however that are clearly lower. Consequently, it is possible to increase the number of sensors and hence to prevent the mechanical complication necessary for moving them.

By way of example, a time-of-flight sensor that meets the above-described specifications is the Creative Interactive Gesture Camera™ sensor.

Further innovative characteristics of the present invention are described in the dependent claims.

According to one aspect of the invention, the acquisition means further comprise at least one unit for dealiasing, with frequency modulation, the distance of the incidence points from the time-of-flight sensor, the dealiasing unit being operatively connected to the sensor and comprising:
first means suitable for controlling the sensor so that the latter measures the phase displacements of the waves by means of at least one first modulation frequency f1 and one second modulation frequency f2 such that f2 is greater than f1, the corresponding depth intervals Z1 and Z2 for measuring without ambiguity being such that Z1 is greater than Z2;
second means for controlling the sensor so that the latter measures the phase displacements by means of a third dealiasing frequency f3 proportional to a value resulting from the following expression: A·f1−B·f2, A and B being weighting coefficients (i.e. coefficients which define the degree of importance of the frequency by which they are multiplied, within the expression for calculating the dealiasing frequency), a third depth interval for measuring without ambiguity Z3, corresponding to the dealiasing frequency f3, being greater than Z1,

the sensor having a resolution for calculating the distance of said incidence points greater than that possessed by the sensor when operating at the frequency f1, ignoring the measurements carried out when operating at the frequency f2, and greater than that possessed by the sensor when operating at the frequency f2, ignoring the measurements carried out when operating at the frequency f1.

Preferably, the modulation frequencies f1, f2 and f3 and the weighting coefficients A and B have a value such that the depth interval for measuring without ambiguity Z3 has an amplitude not less than 3 m.

By “dealiasing unit” it is intended a unit capable of reducing the phenomenon of aliasing by enlarging the depth interval Z for measuring without ambiguity of the time-of-flight sensor, corresponding to the modulation frequency f.

By interval Z for measuring without ambiguity the depth corresponding to the modulation frequency f, it is intended the depth interval, dependent on f, within which the objects reflect signals that are distinguishable by the sensor. By affirming that the dealiasing unit is “with frequency modulation”, it is intended that it controls the sensor so that the latter uses at least two modulation frequencies. According to this aspect of the invention, as an alternative to the abovementioned Creative Interactive Gesture Camera™ sensor, it is possible to use a sensor that constitutes an embodiment of the sensor, object of the U.S. Pat. No. 7,791,715 B1, such as for example the Kinect 2.0 Microsoft® sensor.

Another object of the invention is a method for determining at least one value assumed by at least one parameter characteristic of one or more components of a vehicle in the scope of a diagnostic, maintenance or monitoring operation completed on the vehicle, the method comprising the steps of:
a) arranging vehicle service equipment like that which is the object of the invention;
b) for each sensor, emitting waves incident on the component of the vehicle;
c) for each sensor, receiving the incident waves reflected by said component;
d) for each sensor, measuring phase displacements sustained by the incident waves following the incidence on said component;
e) for each sensor, calculating, on the basis of the phase displacements, the distance from the sensor of the points of said component on which the waves impact, and determining the spatial position of said incidence points with respect to the sensor;
f) for each sensor, transmitting to the first processing unit the distance and the position of said incidence points;
g) calculating, on the basis of said distances and positions, the value assumed by said characteristic parameter.

In the present description, for ease of description, reference is only made to a preferred embodiment of the invention, in which the vehicle service equipment is a device for aligning the wheels of a vehicle, and the method for determining at least one value of the aforesaid characteristic parameter by means of the vehicle service equipment, which is the object of the invention, is a method for indirectly measuring the characteristic size and the angles of the wheels, of the steering and of the chassis of a vehicle in order to allow carrying out the alignment of the wheels thereof. In the form of use of the equipment for verifying the alignment of the tyres, the aforesaid component will therefore preferably be identified in the tyre itself. It must be clear that the vehicle service equipment and the relative method, object of the invention, are not limited to the aforesaid embodiment but respectively consist of vehicle service equipment and of a method which provides for the use thereof, for acquiring, by means of time-of-flight sensors that meet the above-indicated specifications, information regarding the shape of one or more components of a vehicle and/or measuring, without contact, spatial distances relative to said components, and subsequently determining, on the basis of the acquired information and the measured distances, the value of at least one parameter characteristic of said components relative to the type of operation (diagnostic, maintenance or monitoring) that is being carried out. In particular, examples of vehicle service equipment that can be actuated according to the present invention are described in the patent application WO 2014/048831 A1.

### BRIEF DESCRIPTION OF THE FIGURES

Further objects and advantages of the present invention will be clear from the following detailed description of an embodiment thereof and from the enclosed drawings, given as a merely non-limiting example, in which:

FIG. 1 shows, in top schematic plan view, vehicle service equipment according to the present invention;

FIG. 2 shows, in top schematic plan view, a variant of the vehicle service equipment of FIG. 1;

FIG. 3 shows, in top schematic plan view, a variant of the vehicle service equipment of FIG. 2;

FIG. 4 shows, in front schematic plan view, a tower of the vehicle service equipment of FIG. 1 or 2 or 3.

### DETAILED DESCRIPTION OF SEVERAL PREFERRED EMBODIMENTS OF THE INVENTION

In the following description, a figure can also be illustrated with reference to elements not expressly indicated in that figure but in other figures. The scale and proportions of the various depicted elements do not necessarily correspond with the actual scale and proportions.

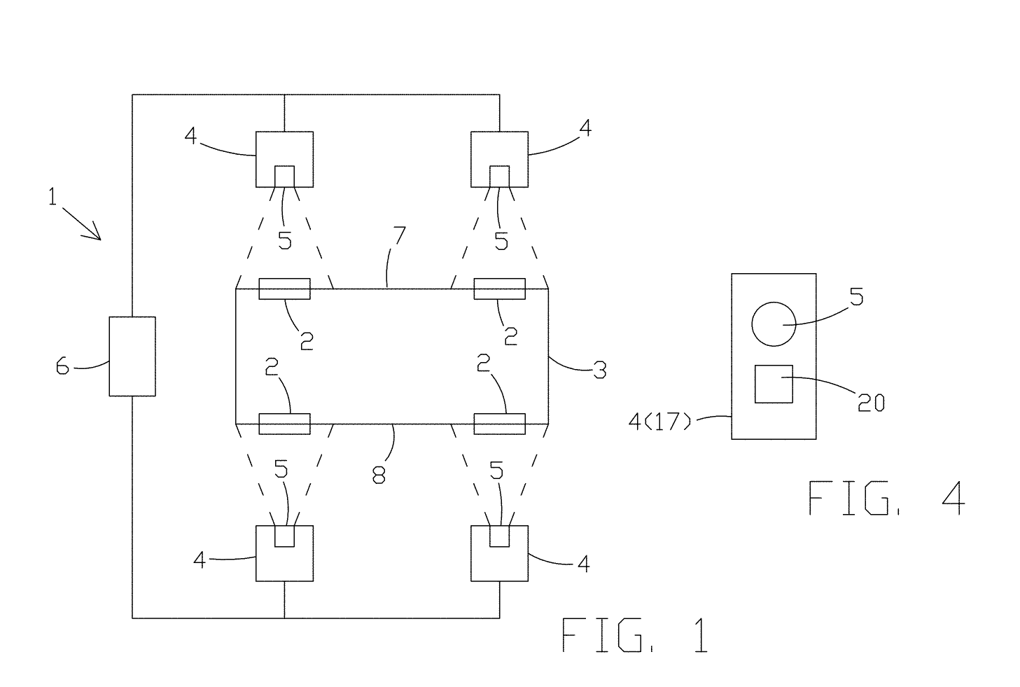

FIG. 1 shows vehicle service equipment 1 belonging to the category of the so-called “wheel alignment devices”, i.e. devices by means of which it is possible to indirectly measure the characteristic size and the angles of the wheels 2, of the steering and of the chassis of a vehicle 3 in order to allow carrying out the alignment of the wheels 2 thereof.

The device 1 comprises a multiplicity of towers 4, each of which comprising a time-of-flight sensor 5 suitable for acquiring, without contact, information relative to the shape, size and position occupied in space by the wheels 2 of the vehicle 3. The device 1 further comprises a processing unit 6 operatively connected to the towers 4 for receiving, from the latter, the information acquired for each wheel 2 and calculating, on the basis of this information, the aforesaid characteristic size and angles for the purpose of aligning the wheels 2 of the vehicle 3. By way of example, the device 1 comprises four towers 4 and the vehicle 3 is a car provided with four wheels 2 lying, two by two, respectively at two mutually opposite sides 7 and 8 of the vehicle 3. The latter is interposed between the towers 4 in a manner such that the sensors 5, overall, are capable of framing all the wheels 2 of the vehicle 3. Incidentally, by affirming that a sensor 5 frames a wheel 2, it is intended that the sensor is capable of acquiring information relative to the shape, size and spatial position of said wheel 2. In particular, the sensors 5 are preferably subdivided into pairs and the towers 4 are positioned, with respect to the vehicle 3, in a manner such that the sensors 5 belonging to the same pair are respectively opposite the sides 7 and 8 of the vehicle 3. Still more preferably, each sensor 5 is opposite a wheel 2. In this configuration, by way of example, the distance of the sensors 5 from the vehicle 3 is such that each sensor 5 is capable of framing only the wheel 2 that is opposite thereto. In an alternative embodiment of the device 1 not shown in the figures, the four towers 4 of the device 1 are positioned, with respect to the vehicle 3, in a manner such that the sensors 5 are opposite the sides 7 and 8 of the vehicle 3 but are not opposite the wheels 2, such that each sensor is capable of framing both wheels 2 present at the side 7 or 8 opposite the sensor.

In another alternative embodiment of the device 1 not shown in the figures, the four towers 4 of the device 1 are positioned, with respect to the vehicle 3, in a manner such that the sensors 5 are not opposite the sides 7 and 8 but, schematizing the plan of the vehicle 3 with a rectangle, are respectively opposite the four vertices of said rectangle.

In another alternative embodiment of the device 1 not shown in the figures, the alignment device comprises only two towers respectively opposite the sides 7 and 8 of the vehicle 3. In this alternative embodiment, the towers must be positioned, with respect to the vehicle 3, in a manner such that the sensor of each tower is capable of framing both the wheels 2 present at the side 7 or 8 opposite the sensor. Alternatively, if each tower is capable of framing only one of the wheels 2 present at the side 7 or 8 opposite the sensor, it is necessary to carry out two acquisitions, one for each pair of wheels. For such purpose, after having carried out the first acquisition, it is necessary to move the vehicle, object of operation, or the towers in a manner such that the acquisition of the other pair of wheels is possible.

In another alternative embodiment of the device 1 not shown in the figures, the alignment device comprises means for moving the sensors 5.

By way of example, due to the movement means, it is possible to follow, with the sensors, the vehicle, object of operation, in the movements to which it is subjected during the alignment procedure (such as, for example, when the vehicle is advanced or lifted on a lift). For such purpose, the movement means can comprise actuators (such as hydraulic cylinders) respectively connected to the towers 4, or they can correspond with the lift itself. In the latter case, the towers 4 are integrally connectable with the lift.

In addition, due to the movement means, it is possible to mitigate the systematic measurement errors due to the quantization of the spatial distance in pixels, i.e. errors due to the fact that the range of variability of a continuous size (in this case, the spatial distance) is subdivided into a finite number of intervals (in this case corresponding to the pixels of the depthmap), in each of which the size being considered constant and substituted with a representative value. For such purpose, the movement means can comprise means suitable for rotating or vibrating each tower 4 (and the respective sensor 5 therewith) around a respective axis that is fixed with respect to the ground.

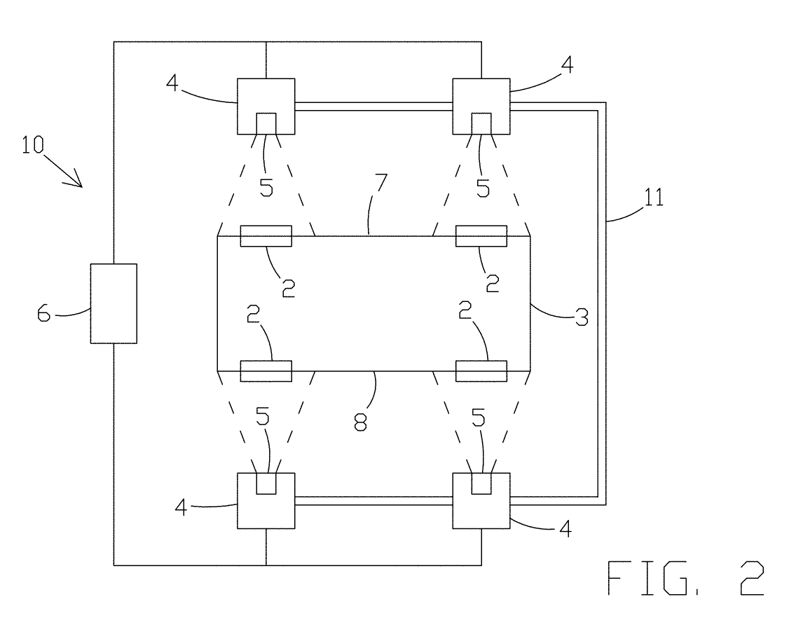

FIG. 2 shows an alignment device 10 that is differentiated from the device 1 in that it comprises a framework 11 to which the towers 4 are connected in a manner such that the sensors 5 are hinged to fulcrums integral with the framework 11 but cannot be translated with respect to each other. Analogous to that stated above with reference to the device 1, the sensors 5 are preferably subdivided into pairs and the vehicle 3 is positioned, with respect to the towers 4, in a manner such that the sensors 5 belonging to the same pair are respectively opposite the sides 7 and 8 of the vehicle 3. Still more preferably, each sensor 5 is situated opposite a wheel 2.

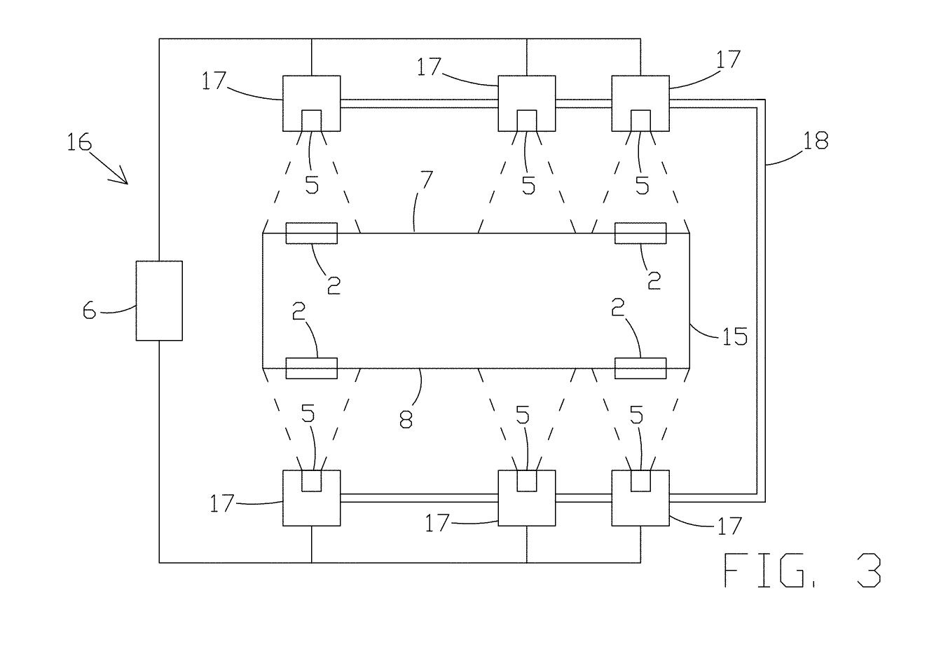

As will be illustrated below, the presence of the framework 11 (and hence the mutual connection between the sensors 5) simplifies, in the device 10, the operations of calibration of the mutual position of the sensors 5 (i.e. the calibration of the position of the sensors 5 in a common reference system), with respect to what occurs in the device 1, but constitutes a disadvantage when it is necessary to carry out an alignment of the wheels 2 of a vehicle 15 (shown in FIG. 3) having a wheelbase greater than that of the vehicle 3, to the point which, by positioning the vehicle 15 such that the front wheels 2 are opposite a first pair of sensors 5, the rear wheels 2 thereof cannot be framed by the second pair of sensors 5.

FIG. 3 shows an alignment device 16 that is differentiated from the device 10 in that it comprises six towers 17 rather than four, such towers also connected to a framework 18 in a manner such that the respective sensors 5 are hinged to fulcrums integral with the framework 18 but cannot be translated with respect to each other. Analogous to the sensors 5 of the towers 4, also the sensors 5 of the towers 17 are preferably subdivided into pairs and the vehicle 15 is positioned, with respect to the towers 17, in a manner such that the sensors 5 belonging to a same pair are respectively opposite the sides 7 and 8 of the vehicle 15. A first pair of sensors 5 is situated at a front portion of the vehicle 15. The other two pairs of sensors 5 are situated at a rear portion of the vehicle 15. The amplitude of the interval of values, assumable by the wheelbase of a vehicle whose wheels fall within the framing of at least one pair of sensors 5 of the device 16, is greater than that of the device 10, given the same distance of the sensors 5 from the vehicle, object of operation. As is possible to observe in FIG. 3, the towers 17 are preferably positioned, with respect to the vehicle 15, in a manner such that: two sensors 5 are respectively opposite the front wheels 2 of the vehicle 15, another two sensors 5 are respectively opposite the rear wheels 2 and the latter two sensors 5 are in intermediate position between the other two pairs of sensors 5. In this manner, the latter two sensors 5 can frame the rear wheels 2 of the vehicle 3, with smaller wheelbase.

Each sensor 5 comprises: an emitter of waves which are incident on wheel 2 of the vehicle 3 (or 15), a receiver of said incident waves after they have been reflected by the wheel 2, and a second processing unit capable of measuring phase displacements sustained by the waves due to the incidence on the wheel 2. On the basis of the measured phase displacements, the second processing unit is capable of calculating the distance from the sensor 5 of the points of the wheel 2 on which the waves emitted by the emitter impact. The second processing unit is also capable of determining the spatial position, with respect to the sensor 5, of the incidence points of the waves on the wheel 2. The information relative to the distance of the incidence points from the sensor 5 can be graphically represented by means of a depthmap in which each pixel corresponds to an incidence point of the wheel 2.

As anticipated above, the waves emitted by the sensors 5 are preferably infrared radiations, and still more preferably they have a wavelength belonging to the so-called “near infrared” interval. The sensors 5 are capable of generating a depthmap with a resolution preferably not less than 320×200 pixel and have a depth resolution preferably greater than 0.2 mm̂−1. Time-of-flight sensors which meet the above specifications are, by way of example, the Creative Interactive Gesture Camera™ sensor and the Kinect 2.0 Microsoft sensor. In the latter case, the sensors 5 further comprise the unit for dealiasing with frequency modulation described above, with a depth interval for measuring without ambiguity having an amplitude of preferably not less than 3 m.

As can be observed in FIG. 4, each tower 4 (or, analogously, 17) can comprise a target 20 integral with the sensor 5 and, with respect to the latter, in a position known to the processing unit 6. The target 20 is capable of diffusing the waves emitted by the emitters of the other sensors 5 and can be twodimensional or three-dimensional. In particular, it can be compared, by way of example, to a grid of points. Possible information on the geometry of the target 20 can be known to the processing unit 6. As will be illustrated hereinbelow, the targets 20 allow carrying out a calibration of the mutual position of the sensors 5.

The targets 20 can be capable of diffusing a light radiation of another origin, e.g. environmental, as an alternative or in addition to the waves emitted by the emitters of the sensors 5. Such radiation can be detected by a second receiver comprised in the sensors 5. The second processing unit is capable of determining the distance of the target 20 from the sensor 5 to which the second processing unit belongs, and the position of the target 20 with respect to such sensor 5, such target 20 connected to another sensor 5. The second receiver can comprise, by way of example, a RGB camera.

As an alternative or in addition to being able to reflect the waves emitted by the emitters of the sensors 5 or the light radiation, the targets 20 can comprise wave emitters, such as light-emitting diodes (also known as “LED”). In such case, the second receivers are also suitable for receiving the waves emitted by the targets 20 so as to allow the second processing unit to be capable of determining the distance of the target 20 from the sensor 5 to which the second processing unit belongs, and the position of the target 20 with respect to such sensor 5, such target 20 connected to another sensor 5.

As will be illustrated hereinbelow, if the sensors 5 cannot be translated with respect to each other but can only be rotated since they are hinged on fulcrums known beforehand to the processing unit 6 (such as in the devices 10 and 16 respectively shown in FIGS. 2 and 3), it is possible to carry out the calibration of the mutual position of the sensors 5 without the sensors 5 having to reconstruct the internal geometry of the targets 20, nor does such geometry have to be known ahead of time to the processing unit 6. In other words, in these cases, the targets 20 are comparable to point-like elements. This allows a considerable structural simplification of the targets 20 both in terms of size reduction and construction accuracy. A necessary condition is that the mutual position of the fulcrums of the sensors 5 is known to the processing unit 6.

Regardless of the type of targets 20, the towers 4 (or, analogously, 17) are positioned, with respect to the vehicle 3 (or 15) in a manner such that the receiver of at least one of the sensors 5 is capable of receiving the waves coming from the target 20 of at least another two sensors 5 lying, with respect to the vehicle 3, on the side opposite said receiver. In other words, with reference to the device 1, at least one of the sensors 5 opposite side 7 of the vehicle 3, must be capable of framing the targets 20 of the two sensors 5 opposite side 8, and at least one of the sensors 5 opposite side 8 of the vehicle 3 must be capable of framing the targets 20 of the two sensors 5 opposite the side 7. During the operations of calibration of the mutual position of the sensors 5, this allows establishing the mutual position of the sensors 5 lying on the same side with respect to the vehicle 3.

In order to increase the resolution of the vehicle service equipment, if the object of scan is tyre parts, advantageously, the reflection on the tyre of the waves emitted by the emitters of the sensors 5 can be increased by integrally applying white color materials to the tyre. Non-limiting examples include chalk powder, or second targets, such as paper adhesives. The geometry of such second targets can be known to the processing unit 6. Practical tests carried out by the Applicant demonstrate a doubling of the resolution of the vehicle service equipment following the application of white targets on the wheels, object of alignment. Having examined the vehicle service equipment, object of the invention, in its entirety and with regard to its possible variants, a method is now described—that is also the object of the invention—for indirectly measuring the characteristic size and angles of the wheels 2, of the steering and of the chassis of a vehicle 3 or 15 in order to allow carrying out the alignment of the wheels 2. The method comprises the steps of:
a) arranging vehicle service equipment according to the present invention, such as the alignment device 1 or 10 or 16;
b) positioning the towers 4 (or, analogously, 17), with respect to the vehicle 3 (o 15), in a manner such that each wheel 2 is frameable by at least one of the sensors 5. Preferably, the towers 4 (or 17) are positioned in a manner such that each wheel 2 is opposite one of the sensors 5;
c) emitting, from each sensor 5, by means of the respective emitter, waves incident on the wheel 2 opposite the sensor 5;
d) receiving, in each sensor 5, by means of the respective receiver, the incident waves that have been reflected by the wheel 2;
e) measuring, in each sensor 5, by means of the second processing unit, the phase displacements sustained by the incident waves following the incidence on the wheel 2;
f) calculating, on the basis of said phase displacements, in each sensor 5, by means of the second processing unit, the distance from the sensor 5 of the points of the wheel 2 on which the waves impact, and determining the spatial position of said incidence points with respect to the sensor 5;
g) transmitting the information relative to the distance and position of the incidence points of each wheel 2 from the second processing units of the sensors 5 to the processing unit 6 for calculating, on the basis of this information, aforesaid characteristic size and angles of the wheels 2, of the steering and of the chassis of the vehicle 3 or 15 for the purpose of alignment of the wheels 2.

As stated above, the presence of the targets 20 allows carrying out a calibration of the mutual position of the sensors 5 before the start of the acquisition of the information relative to the shape, size and position from the wheels 2. When it is desired to carry out said calibration, the above-described method comprises, between step b) and step c), the following steps:
b1) emitting, from each sensor 5, by means of the respective emitter, waves incident on a target 20 connected to at least one other sensor 5 lying, with respect to the vehicle 3, on the side opposite said emitter;
b2) receiving, in each sensor 5, by means of the respective receiver, the incident waves that were reflected by the target 20;
b3) measuring, in each sensor 5, by means of the second processing unit, the phase displacements sustained by the incident waves following the incidence on the target 20;
b4) calculating, on the basis of said phase displacements, in each sensor 5, by means of the second processing unit, the distance from the sensor 5 of the points of the target 20 on which the waves impact, and determining the spatial position of said incidence points with respect to the sensor 5;
b5) transmitting the information relative to the distance and position of the incidence points of each target 20 from the second processing units of the sensors 5 to the processing unit 6 for determining, on the basis of this information and possibly the geometry of the target 20, the mutual position of the targets 20 and hence of the sensors 5, thus carrying out said calibration.

The calibration is carried out by generating a depthmap for each of the targets 20 by means of the same emitters and receivers with which the depthmaps of the wheels 2 are generated.

In addition to that stated, in step b) it is necessary to position the towers 4, with respect to the vehicle 3, not only in a manner such that each wheel 2 is frameable by at least one of the sensors 5, but also in a manner such that, for each side 7 and 8 of the vehicle 3, at least one of the two sensors 5 is capable of framing the target 20 of the two sensors 5 lying on the side opposite the vehicle 3. For the calibration of the mutual position of the sensors 5 to be possible, since each sensor 5 framing the target 20 cannot be connected to the other sensor 5 lying at the same side 7 or 8 of the vehicle 3, at least one of the two sensors 5 must frame the target 20 of both the sensors 5 lying on the side opposite the vehicle 3, so as to acquire information on the mutual position thereof. If the targets 20 are capable of reflecting a light radiation, for the purpose of the calibration of the mutual position of the sensors 5:
the abovementioned step b1) is absent;
step b2) consists of receiving, in each sensor 5, by means of the respective second receiver, the light radiation reflected by the target 20;
steps b3) and b4) consist of determining the distance of the target 20 from the sensor 5 and the position of such target 20 with respect to the sensor 5.

In such case, the calibration is not carried out by means of the emitters and receivers with which the depthmaps of the wheels 2 are generated, but rather by means of second receivers, for example the abovementioned RGB cameras. Analogous considerations hold true if the targets 20 comprise light-emitting diodes.

If the sensors 5 are completely movable with respect to each other (such as in the device 1), for the calibration of the mutual position between the sensors 5 to be reduced to a calibration of the angle thereof, between step b) and step b1) it is necessary to complete the following steps:
bb1) mutually connecting the sensors 5 in a manner such that the same cannot be translated with respect to each other (so as to obtain, for example, the device 10 or 16);
bb2) determining the mutual distances of the sensors 5;
bb3) transmitting said mutual distances to the processing unit 6.

As mentioned above, the presence of the movement means, particularly when they comprise vibration means, allows at least partially correcting a systematic error due to the quantization of the spatial distance in pixels. For such purpose, after having executed the steps from c) to f), before executing step g), it is necessary to move the sensors 5 by means of the movement means, repeating steps c) to f) and, at step g), transmitting to the processing unit 6 the average value of the two measured distances and of the two positions determined for each incidence point of each wheel 2. The higher the number of times that steps from c) to f) are repeated, the better the correction of the aforesaid systematic error. By “average position” of a point, it is intended the average value assumed by the three Cartesian coordinates which identify the position of the point in a three-dimensional Cartesian reference system.

In particular, in order to reduce the systematic error, it is necessary to complete the following steps between step f) and step g):
f1) moving said sensor with respect to said component;
f2) repeating at least once the steps from c) to f1);
f3) for each incidence point, calculating the average value assumed by the measured distances and by the positions determined for the incidence point.

On the basis of the description provided for a preferred embodiment, it is clear that some changes can be introduced by the man skilled in the art without departing from the scope of the invention, as defined by the following claims.

1. Vehicle service equipment (1, 10, 16) for determining at least one value assumed by at least one parameter characteristic of one or more components (2) of a vehicle (3, 15) in the scope of a diagnostic, maintenance or monitoring operation completed on said vehicle (3, 15),
said vehicle service equipment (1, 10, 16) comprising:
acquisition means (5) for acquiring, without contact, data comprising information relative to the shape of said component (2) and/or at least one size of at least one spatial distance relative to said component (2);
a first processing unit (6) operatively connected to said acquisition means (5) for receiving said acquired data from the latter,
said first processing unit (6) being suitable for calculating, on the basis of said acquired data, the value assumed by said characteristic parameter,
wherein said acquisition means (5) include at least one time-of-flight sensor (5) comprising:
first means for emitting waves incident on said component (2);
first means for receiving said incident waves reflected by said component (2);
a second processing unit for:
measuring phase displacements sustained by said incident waves following the incidence on said component (2), and calculating, on the basis of said phase displacements, the distance from said sensor (5) of the points of said component (2) on which said waves impact;
determining the spatial position of said incidence points with respect to said sensor (5),
said sensor (5) being capable of generating a depthmap with resolution not less than 320×200 pixel and having a depth resolution greater than 0.2 mm̂−1.

2. Vehicle service equipment (1, 10, 16) according to claim 1, wherein said acquisition means (5) comprise at least one unit for dealiasing, with frequency modulation, the distance of said incidence points from said sensor (5), said dealiasing unit being operatively connected to said sensor (5), said dealiasing unit comprising:
first means for controlling said sensor (5) such that the latter measures said phase displacements by means of at least one first modulation frequency f1 and one second modulation frequency f2 such that f2 is greater than f1, the corresponding intervals Z1 and Z2 for measuring without ambiguity being such that Z1 is greater than Z2;
second means for controlling said sensor (5) such that the latter measures said phase displacements by means of a third dealiasing frequency f3 proportional to A·f1−B·f2, A and B being weighting coefficients, a third interval Z3 for measuring without ambiguity, corresponding to the dealiasing frequency f3, being greater than Z1.

3. Vehicle service equipment (1, 10, 16) according to claim 1, further comprising a plurality of sensors (5), said sensors (5) being arranged in a manner such to frame points of a plurality of components (2) of said vehicle (3, 15).

4. Vehicle service equipment according to claim 3, wherein said sensors (5) are subdivided into pairs, the sensors (5) belonging to the same pair being respectively opposite two sides (7, 8) of said vehicle (15) at which said components (2) are present, said vehicle service equipment comprising only one pair of sensors (5).

5. Vehicle service equipment (16) according to claim 3, wherein said sensors (5) are subdivided into pairs, the sensors (5) belonging to the same pair being respectively opposite two sides (7, 8) of said vehicle (15) at which said components (2) are present, said vehicle service equipment (16) comprising at least three pairs of sensors (5), one of said pairs of sensors (5) being situated at a front portion of said vehicle (15), the other two said pairs of sensors (5) being situated at a rear portion of said vehicle (5).

6. Vehicle service equipment (1, 10, 16) according to claim 3, further comprising means for moving said sensors (5).

7. Vehicle service equipment (1, 10, 16) according to claim 3, wherein each of said sensors (5) is integrally connected to at least one first target (20), said first target (20) being, with respect to said sensor (5), in a position known to said first processing unit (6),
each of said sensors (5) comprising means suitable for receiving waves coming from said first target (20) connected to one of the other sensors (5),
said second processing unit also being suitable for determining the distance from said sensor (5) and the position with respect to said sensor (5) of said first target (20), on the basis of said received waves and possibly information on the geometry of said first target (20) known to said second processing unit.

8. Vehicle service equipment (1, 10, 16) according to claim 7, wherein said sensors (5) are arranged in a manner such that said means for receiving at least one of said sensors (5) are capable of receiving said waves coming from said first target (20) of at least two other said sensors lying, with respect to said vehicle (3, 15), on the side opposite said receptor means.

9. Vehicle service equipment (1, 10, 16) according to claim 3, further comprising at least one second white target connectable to one tyre of said wheel (2) and frameable by at least one of said sensors (5).

10. Method for determining at least one value assumed by at least one characteristic parameter of one or more components of a vehicle (3, 15) in the scope of a diagnostic, maintenance or monitoring operation completed on said vehicle (3, 15), said method comprising the steps of:
a) arranging vehicle service equipment (1, 10, 16) according to claim 3;
b) for each of said sensors (5), emitting waves incident on one of said components (2);
c) for each of said sensors (5), receiving said incident waves reflected by said component (2);
d) for each of said sensors (5), measuring phase displacements sustained by said incident waves following the incidence on said component (2);
e) for each of said sensors (5), calculating, on the basis of said phase displacements, the distance from said sensor (5) of the points of said component (2) on which said waves impact, and determining the spatial position of said incidence points with respect to said sensor (5);
f) for each of said sensors (5), transmitting to said first processing unit (6) the distance and the position of said incidence points of said component (2);
g) calculating, on the basis of said distances and positions, the value assumed by said characteristic parameter.

11. Method according to claim 10, wherein the vehicle service equipment in step a) comprises means for moving said sensors,
and the method comprises, between step a) and step b), the following steps:
a1) for each of said sensors (5), receiving waves from said first target (20) connected to at least another of said sensors (5);
a2) for each of said sensors (5), determining the distance from said sensor (5) and the position with respect to said sensor (5) of said first target (20);
a3) for each of said sensors (5), transmitting to said first processing unit (6) the distance and the position of said first target (20);
a4) determining the mutual positions of said sensors (5).

12. Method according to claim 11, further comprising, between step a) and step a1), the following steps:
aa1) mutually connecting said sensors (5) in a manner such that said sensors (5) cannot be translated with respect to each other;
aa2) determining the mutual distances of said sensors (5);
aa3) transmitting said mutual distances to said first processing unit (6).

13. Method according to claim 10, wherein the sensors of the vehicle service equipment in step a) are subdivided into pairs, the sensors (5) belonging to the same pair being respectively opposite two sides (7, 8) of said vehicle (15) at which said components (2) are present, said vehicle service equipment (16) comprising at least three pairs of sensors (5), one of said pairs of sensors (5) being situated at a front portion of said vehicle (15), the other two said pairs of sensors (5) being situated at a rear portion of said vehicle,
and the method comprises, between step e) and step f), the following steps:
e1) moving said sensor (5) with respect to said component (2);
e2) repeating at least once the steps from b) to e1);
e3) for each incidence point, calculating the average value assumed by said distances and said positions;
step f) consisting of calculating the value assumed by said characteristic parameter on the basis of said average distances and said average positions.
